(19) United States
(12) Patent Application Publication
(10) Pub. No.: US 2025/0026002 A1
(43) Pub. Date: Jan. 23, 2025

(54) MUSCULAR STRENGTH ASSISTING APPARATUS AND MUSCULAR STRENGTH ASSISTING SYSTEM INCLUDING THE SAME

(71) Applicants: Hyundai Motor Compaby, Seoul (KR); Kia Corporation, Seoul (KR)

(72) Inventors: Kyu Jung KIM, Seoul (KR); Sung Woo Park, Seoul (KR); Hyun Seop Lim, Anyang -Si (KR); Ju Young Yoon, Suwon-Si (KR); Beom Su Kim, Yongin-Si (KR); Min Woong Jeung, Seoul (KR); Seong Taek Hwang, Suwon-Si (KR); Hyeon Jeong An, Seoul (KR); Ho Jun Kim, Gunpo-Si (KR); Moon Ki Jung, Seoul (KR); Soo Kyung Kang, Gunpo-Si (KR); Dong Jin Hyun, Suwon-Si (KR); Hyo Joong Kim, Seongnam-Si (KR)

(73) Assignees: Hyundai Motor Company, Seoul (KR); Kia Corporation, Seoul (KR)

(21) Appl. No.: 18/734,954

(22) Filed: Jun. 5, 2024

(30) Foreign Application Priority Data
Jul. 18, 2023 (KR) 10-2023-0093162

(51) Int. Cl. B25J 9/00

(52) U.S. Cl. CPC B25J 9/0006

(57) ABSTRACT

A muscular strength assisting apparatus includes a muscular strength assisting portion that assists a user's muscular strength and a first connecting link including one side connected to one side of the muscular strength assisting portion and an opposite side rotatable relative to a shoulder of the user about a first rotation axis. The muscular strength assisting portion includes an upper arm module that assists muscular strength of an upper arm of the user and a link assembly including one side connected to one side of the upper arm module to be rotatable about a second rotation axis non-parallel to the first rotation axis and an opposite side disposed adjacent to a portion of a body of the user to be supported on the user.

### CROSS-REFERENCE TO RELATED APPLICATION

The present application claims priority to Korean Patent Application No. 10-2023-0093162, filed on Jul. 18, 2023, the entire contents of which is incorporated herein for all purposes by this reference.

### BACKGROUND OF THE PRESENT DISCLOSURE

### Field of the Present Disclosure

The present disclosure relates to a muscular strength assisting apparatus and a muscular strength assisting system including the same, and more particularly, relates to a muscular strength assisting apparatus for providing an assisting force for a user's joint motion and a muscular strength assisting system including the muscular strength assisting apparatus.

### Description of Related Art

A muscular strength assisting apparatus that provides an assisting force to a user's upper arm when the user performs a task while the muscular strength assisting apparatus is worn on the user's upper body may assist the user by providing a force pressing the user's arm upwards. The muscular strength assisting apparatus serves to assist the user when the user performs various tasks requiring a posture with arms raised, such as a task performed under a vehicle. In recent years, studies on a muscular strength assisting apparatus capable of being selectively used for only one of a left upper arm and a right upper arm of a user that requires muscular strength assistance have been increasingly conducted.

A muscular strength assisting system in the related art includes a first muscular strength assisting apparatus and a second muscular strength assisting apparatus that assist the muscular strengths of a user's left and right upper arms, respectively. While the muscular strength of one of the user's left and right upper arms is assisted by one of the two muscular strength assisting apparatuses, the one muscular strength assisting apparatus has to be supported on the user to remain at an aligned position relative to the user's shoulder. For example, the first muscular strength assisting apparatus is supported on the user through the second muscular strength assisting apparatus while assisting the muscular strength of the user's left upper arm.

Meanwhile, when the muscular strength assisting system in the related art includes only the first muscular strength assisting apparatus and does not include the second muscular strength assisting apparatus, a first muscular strength assisting portion may not be supported on the user while assisting the muscular strength of the user's upper arm, and therefore a position relative to the user's shoulder may not be aligned.

Accordingly, there is an increasing demand for a muscular strength assisting apparatus having a structure independently supported on a user without any other muscular strength assisting apparatus while assisting only the muscular strength of one of the user's left and right upper arms.

The information included in this Background in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a muscular strength assisting apparatus including a structure independently supported on a user without any other muscular strength assisting apparatus.

Another aspect of the present disclosure provides a muscular strength assisting apparatus configured for being selectively used for only one of a left upper arm and a right upper arm of a user that requires muscular strength assistance.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a muscular strength assisting apparatus includes a muscular strength assisting portion that assists a user's muscular strength and a first connecting link including one side connected to one side of the muscular strength assisting portion and an opposite side rotatable relative to a shoulder of the user about a first rotation axis. The muscular strength assisting portion includes an upper arm module that assists muscular strength of an upper arm of the user and a link assembly including one side connected to one side of the upper arm module to be rotatable about a second rotation axis non-parallel to the first rotation axis and an opposite side disposed adjacent to a portion of a body of the user to be supported on the user.

The one side of the upper arm module may be turned around a virtual first rotation center extending along the first rotation axis.

The first connecting link and the opposite side of the link assembly may be spaced from each other in a direction of the first rotation axis.

The upper arm module may be spaced from a virtual straight line passing through the opposite side of the first connecting link and the opposite side of the link assembly.

When a direction perpendicular to an extension direction of the first rotation axis is referred to as a radial direction, a radius of rotation of the one side of the upper arm module may be a separation distance between the first rotation axis and the one side of the upper arm module in the radial direction.

When the muscular strength assisting apparatus is viewed in a direction of the first rotation axis, the opposite side of the link assembly may be located within a virtual circle whose center passes through the first rotation axis and whose radius is the radius of rotation of the one side of the upper arm module.

The muscular strength assisting apparatus may further include a second connecting link that allows the one side of the upper arm module to turn around the first rotation center within a range of a first rotation angle.

The second connecting link may have one side fixed in position relative to the body of the user and an opposite side connected to the one side of the muscular strength assisting portion.

Based on when the muscular strength assisting apparatus is viewed along the first rotation axis, a virtual straight line extending in a direction in which the first rotation axis faces toward the one side of the upper arm module may be referred to as a first straight line, and a virtual straight line extending in a direction in which the first rotation axis faces toward the one side of the second connecting link may be referred to as a second straight line. An upper arm rotation angle formed by the one side of the upper arm module may be defined as an angle formed by the first straight line and the second straight line, and the upper arm rotation angle may be less than or equal to the first rotation angle.

The second connecting link may include an elastic material.

According to another aspect of the present disclosure, a muscular strength assisting system includes a muscular strength assisting apparatus that assists a user's muscular strength, a harness including a shoulder portion configured to be brought into close contact with a shoulder of the user and a body portion configured to be brought into close contact with a body of the user, and an adapter that connects the harness and the muscular strength assisting apparatus to each other. The muscular strength assisting apparatus includes a muscular strength assisting portion that assists the user's muscular strength and a first connecting link including one side connected to one side of the muscular strength assisting portion and an opposite side connected to the shoulder portion to be rotatable about a first rotation axis. The muscular strength assisting portion includes an upper arm module that assists muscular strength of an upper arm of the user and a link assembly including one side connected to one side of the upper arm module to be rotatable about a second rotation axis non-parallel to the first rotation axis and an opposite side connected to a portion of the body portion by the adapter.

The adapter may include a fixed portion fixed to a portion of the body portion and a rotation portion connected to the fixed portion to be rotatable.

The opposite side of the link assembly may include an intersection region that crosses three rotation axes whose centers cross one another and turns about the three rotation axes, and the intersection region may be rotatably connected to the rotation portion so that a center of the intersection region is fixed relative to the rotation portion when the intersection region is turned about the three rotation axes.

The intersection region may be moved toward or away from the fixed portion when the rotation portion is turned relative to the fixed portion.

One end portion of the rotation portion may be connected to one end portion of the fixed portion to be rotatable. An opposite end portion of the rotation portion may be moved toward or away from an opposite end portion of the fixed portion when the rotation portion is turned relative to the fixed portion. The intersection region may be disposed between the one end portion of the rotation portion and the opposite end portion of the rotation portion.

The muscular strength assisting portion may further include a seating cuff on which the upper arm of the user is accommodated and which is connected to the upper arm module and a cuff fastening portion connected to the seating cuff and fastened to the harness. The harness may include a wearable vest that forms the shoulder portion and the body portion and a vest fastening portion fixedly disposed on the wearable vest and selectively fastened with the cuff fastening portion.

The vest fastening portion may include a plurality of vest fastening portions disposed on an upper portion, a center portion, and a lower portion of the body portion, respectively. The upper portion of the body portion may be brought into close contact with a pectoralis major muscle of the user, the lower portion of the body portion may be brought into close contact with a waist of the user, and the center portion of the body portion may be disposed between the upper portion of the body portion and the lower portion of the body portion.

The harness may further include a reaction force applying portion that applies a second reaction force to the link assembly to suppress movement of the opposite side of the link assembly relative to the user due to a first reaction force when the first reaction force is applied to the opposite side of the link assembly by a force applied to the upper arm module.

The reaction force applying portion may be disposed on a lower portion of the harness and may be supported on a lower body of the user.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a perspective view of a muscular strength assisting system according to an exemplary embodiment of the present disclosure;

FIG. 2 is a perspective view exemplarily illustrating a portion of the muscular strength assisting system according to an exemplary embodiment of the present disclosure;

FIG. 3 is a schematic view of a muscular strength assisting apparatus according to an exemplary embodiment of the present disclosure;

FIG. 4 is a perspective view of the muscular strength assisting apparatus according to an exemplary embodiment of the present disclosure;

FIG. 5 is an exploded perspective view of the muscular strength assisting apparatus according to an exemplary embodiment of the present disclosure;

FIG. 6 is an enlarged view of “A” illustrated in FIG. 4;

FIG. 7 is a view exemplarily illustrating a state in which a rotation portion of FIG. 6 is turned relative to a fixed portion;

FIG. 8 is a schematic view exemplarily illustrating the muscular strength assisting system as viewed in a direction of a first rotation axis according to an exemplary embodiment of the present disclosure;

FIG. 9 is a schematic view exemplarily illustrating the muscular strength assisting system in a state in which an upper arm rotation angle is increased when compared to that in the muscular strength assisting system of FIG. 8;

FIG. 10 is a schematic view exemplarily illustrating a state in which a shoulder of a user of FIG. 9 is moved forward with a predetermined distance;

FIG. 11 is a schematic view exemplarily illustrating the muscular strength assisting system in a state in which the upper arm rotation angle is increased when compared to that in the muscular strength assisting system of FIG. 9;

FIG. 12 is a schematic view exemplarily illustrating a state in which the shoulder of the user of FIG. 11 is moved forward with a predetermined distance;

FIG. 13 is a schematic view exemplarily illustrating a side view of the muscular strength assisting system and the user according to an exemplary embodiment of the present disclosure;

FIG. 14 is a schematic view exemplarily illustrating a rear view of the muscular strength assisting system and the user according to an exemplary embodiment of the present disclosure;

FIG. 15 is a view exemplarily illustrating a harness according to an exemplary embodiment of the present disclosure; and

FIG. 16 is a view exemplarily illustrating a muscular strength assisting apparatus according to another exemplary embodiment of the present disclosure.

It may be understood that the appended drawings are not necessarily to scale, presenting a somewhat simplified representation of various features illustrative of the basic principles of the present disclosure. The predetermined design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to the exemplary drawings. In adding the reference numerals to the components of each drawing, it should be noted that the identical or equivalent component is designated by the identical numeral even when they are displayed on other drawings. Furthermore, in describing the exemplary embodiment of the present disclosure, a detailed description of well-known features or functions will be ruled out in order not to unnecessarily obscure the gist of the present disclosure.

In describing the components of the exemplary embodiment of the present disclosure, terms such as first, second, “A”, “B”, (a), (b), and the like may be used. These terms are merely intended to distinguish one component from another component, and the terms do not limit the nature, sequence or order of the components. When a component is referred to as “connected to”, “supported on”, or “disposed on” another component, this may mean the component is not only directly “connected to”, “supported on”, or “disposed on” the other component but is also indirectly “connected to”, “supported on”, or “disposed on” the other component via a third component.

Hereinafter, a muscular strength assisting system 1 according to an exemplary embodiment of the present disclosure will be described with reference to the accompanying drawings.

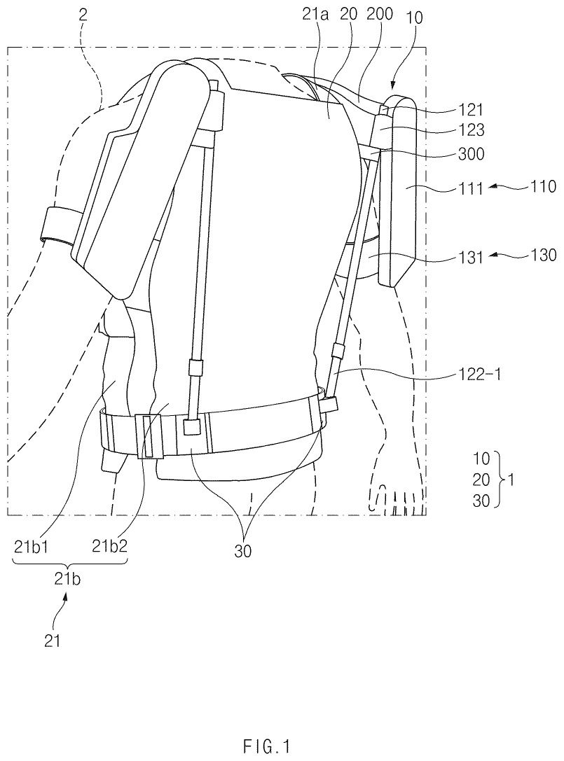

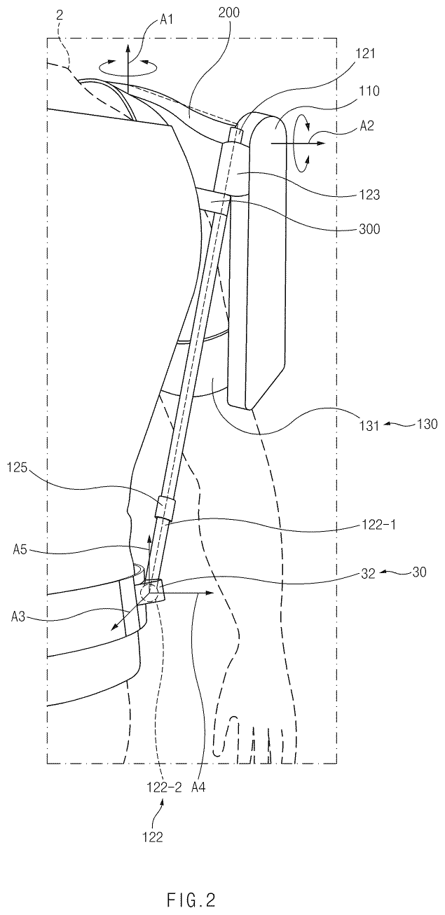

Referring to FIGS. 1 to 7, the muscular strength assisting system 1 may assist the muscular strength of an upper arm of a user 2. For example, the muscular strength assisting system 1 may reduce the muscular strength consumed by the user 2 when the user 2 raises the arm. In more detail, the muscular strength required for the user 2 to raise the arm without the muscular strength assisting system 1 may be greater than the muscular strength required for the user 2 to raise the arm using the muscular strength assisting system 1. The muscular strength assisting system 1 may include a muscular strength assisting apparatus 10, a harness 20, and an adapter 30.

The muscular strength assisting apparatus 10 may assist the muscular strength of the left or right upper arm of the user 2. The muscular strength assisting apparatus 10 may include a plurality of muscular strength assisting apparatuses 10. The plurality of muscular strength assisting apparatuses 10 may be implemented with separate modules. The plurality of muscular strength assisting apparatuses 10 may include a left muscular strength assisting apparatus and a right muscular strength assisting apparatus.

The left muscular strength assisting apparatus may assist the muscular strength of the left upper arm of the user 2. The left muscular strength assisting apparatus may be selectively connectable to the left side of the harness 20. Furthermore, the right muscular strength assisting apparatus may assist the muscular strength of the right upper arm of the user 2. The right muscular strength assisting apparatus may be selectively connectable to the right side of the harness 20. In other words, only the left muscular strength assisting apparatus may be connected to the harness 20. Alternatively, only the right muscular strength assisting apparatus may be connected to the harness 20. In another case, the left muscular strength assisting apparatus and the right muscular strength assisting apparatus may be connected to the harness 20. The muscular strength assisting apparatus 10 may include a muscular strength assisting portion 100, a first connecting link 200, and a second connecting link 300.

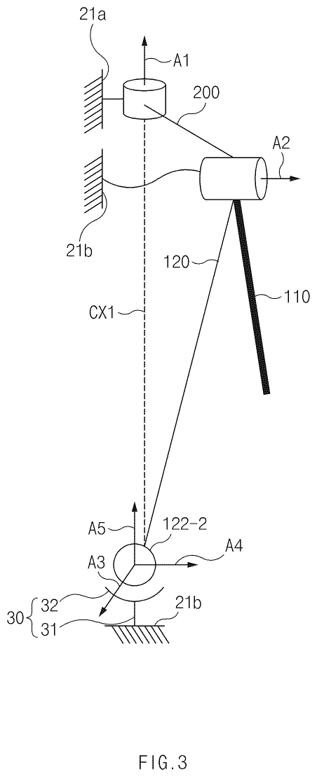

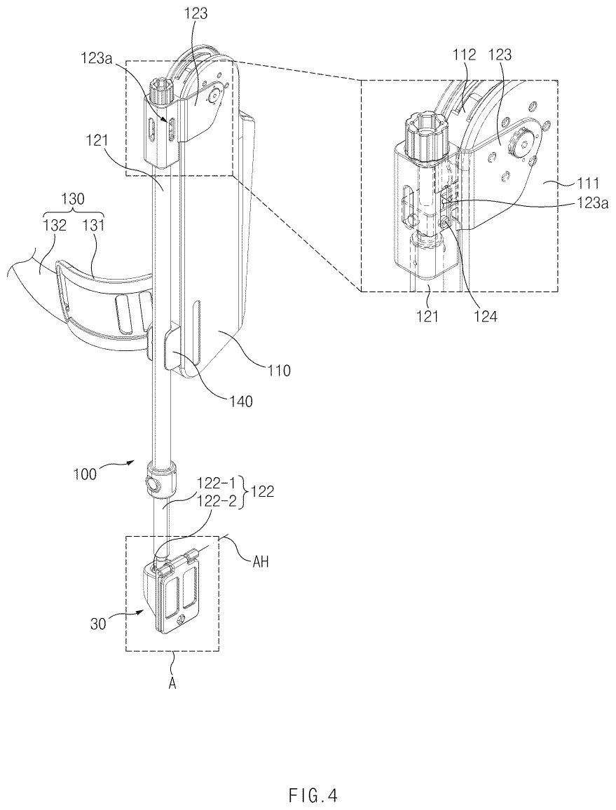

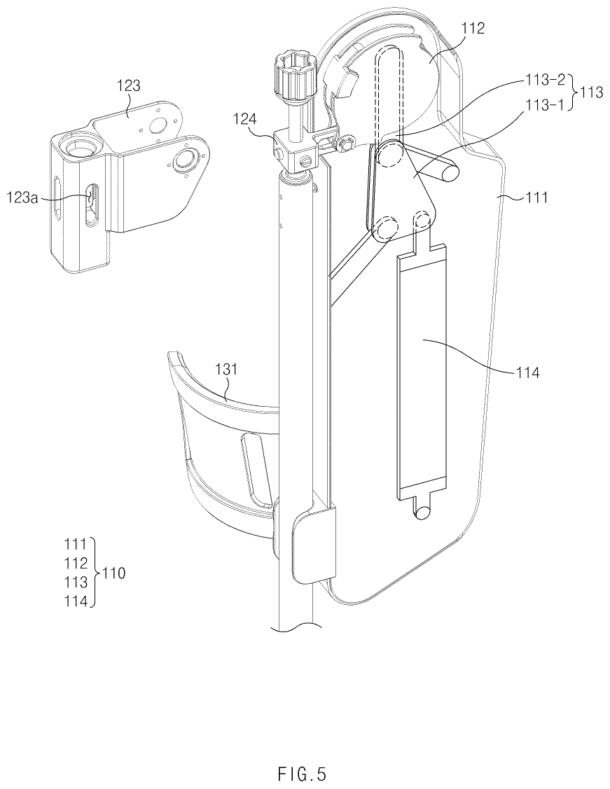

Referring again to FIG. 3, FIG. 4, and FIG. 5, the muscular strength assisting portion 100 may be worn on the upper arm of the user 2. The muscular strength assisting portion 100 may include an upper arm module 110, a link assembly 120, a cuff portion 130, and a stopper 140.

The upper arm module 110 may provide a force to the upper arm of the user 2 in response to movement of the arm of the user 2. The upper arm module 110 may provide the force to the upper arm of the user 2 in a direction in which the user 2 raises the arm. For example, when the user 2 has a first posture in which the user 2 does not raise the arm, the upper arm module 110 may press the upper arm of the user 2 in a horizontal direction thereof. The upper arm module 110 may press the upper arm of the user 2 in the horizontal direction and the upward direction while the user 2 raises the arm in the first posture.

Furthermore, the upper arm module 110 may passively provide a variable assisting force to the user 2 depending on the posture of the user 2. However, the spirit and scope of the present disclosure is not limited thereto, and the upper arm module 110 may actively provide an assisting force to the user 2 using a power source such as a motor.

Referring again to FIG. 3, one side of the upper arm module 110 may be turned around a first rotation center CX1. The first rotation center CX1 may be defined as a virtual straight line extending along a first rotation axis A1. The first rotation axis A1 may be defined as a virtual straight line passing through a shoulder 2a of the user 2 and extending in one direction when the user 2 wears the harness 20. For example, the first rotation axis A1 may be defined as a virtual straight line extending in the up and down direction, based on when the user 2 stands up and has the first posture.

For example, the upper arm module 110 may be revolved around the first rotation center CX1 in a state of being spaced from the first rotation center CX1. In other words, when a component is turned about a rotation axis, this may mean that the component is rotated about the rotation axis. Furthermore, when a component is turned around a rotation center, this may mean that the component is revolved around the rotation center. Furthermore, the one side of the upper arm module 110 may refer to a portion connected to the link assembly 120 to be rotatable.

The upper arm module 110 may be spaced from a reference straight line which is a virtual straight line passing through an opposite side of the first connecting link 200 and an opposite side of the link assembly 120 that will be described below. For example, the reference straight line may be a virtual straight line passing through the opposite side of the first connecting link 200 and an intersection region 122-2.

The radius of rotation of the one side of the upper arm module 110 may be defined as a rotation distance which is a separation distance between the first rotation axis A1 and the one side of the upper arm module 110 in a radial direction. The radial direction may be defined as a direction perpendicular to the extension direction of the first rotation axis A1. For example, the radial direction may be defined as one direction in which the first rotation axis A1 faces toward the one side of the upper arm module 110, based on when the muscular strength assisting apparatus 10 is viewed in the direction of the first rotation axis A1.

When the rotation distance changes, the radius of rotation of the one side of the upper arm module 110 may be changed to correspond to the rotation distance. For example, the first connecting link 200 may be formed of a flexible material which may be bent so that the separation distance between opposite end portions is decreased. Accordingly, when the first connecting link 200 is bent by movement of the user 2 so that opposite end portions move toward each other, the rotation distance may be decreased. When the rotation distance is decreased as described above, the radius of rotation of the one side of the upper arm module 110 may also be decreased.

The upper arm module 110 may include a frame 111, a rotary drive portion 112, a power transmission portion 113, and an elastic portion 114.

Referring again to FIG. 4 and FIG. 5, the frame 111 may form the exterior of the upper arm module 110. For example, one side of the frame 111 may form the exterior of the one side of the upper arm module 110. Furthermore, an opposite side of the frame 111 may form the exterior of the opposite side of the upper arm module 110. The frame 111 may support the rotary drive portion 112, the power transmission portion 113, and the elastic portion 114.

The rotary drive portion 112 may be turned about a second rotation axis A2 non-parallel to the first rotation axis A1. The second rotation axis A2 may be a virtual straight line that passes through the center of the rotary drive portion 112 and extends in a direction not aligned with the first rotation axis A1 (e.g., a direction perpendicular to the first rotation axis A1).

One side of the rotary drive portion 112 may be connected to the link assembly 120. The rotary drive portion 112 may be turned by the link assembly 120. For example, when the link assembly 120 is moved relative to the frame 111 (e.g., turned relative to the frame 111), the rotary drive portion 112 may be turned relative to the frame 111 by rotation of the link assembly 120.

An opposite side of the rotary drive portion 112 may be connected to the power transmission portion 113 to be rotatable. The one side and the opposite side of the rotary drive portion 112 may be spaced from the second rotation axis A2. Furthermore, the one side and the opposite side of the rotary drive portion 112 may refer to two regions spaced from each other in the circumferential direction of the rotary drive portion 112. The rotary drive portion 112 may have, for example, a disk shape. Furthermore, the rotary drive portion 112 may form the one side of the upper arm module 110. The one side of the upper arm module 110 may refer to, for example, a portion of the upper arm module 110 connected to the link assembly 120.

The power transmission portion 113 may transmit an elastic force formed by the elastic portion 114 to the rotary drive portion 112. The power transmission portion 113 may include a first power transmission link 113-1 and a second power transmission link 113-2.

One side of the first power transmission link 113-1 may be connected to the second power transmission link 113-2 to be rotatable. Furthermore, an opposite side of the first power transmission link 113-1 may be connected to the elastic portion 114 to be rotatable. The first power transmission link 113-1 may include a link structure which is supported on the frame 111 to be rotatable.

One side of the second power transmission link 113-2 may be connected to the opposite side of the rotary drive portion 112 to be rotatable. Furthermore, an opposite side of the second power transmission link 113-2 may be connected to the one side of the first power transmission link 113-1 to be rotatable.

The elastic portion 114 may provide a tensile force to the first power transmission link 113-1. One side of the elastic portion 114 may be fixed to the frame 111. Furthermore, an opposite side of the elastic portion 114 may be fixed to the opposite side of the first power transmission link 113-1. The elastic portion 114 may extend between the opposite side of the first power transmission link 113-1 and the opposite side of the frame 111.

For example, the elastic portion 114 may be stretched when the separation distance between the opposite side of the first power transmission link 113-1 and the opposite side of the frame 111 is increased. Furthermore, the elastic portion 114 may be contracted when the separation distance between the opposite side of the first power transmission link 113-1 and the opposite side of the frame 111 is decreased.

The elastic portion 114 may be, for example, a tension spring. When the elastic portion 114 is stretched, the tensile force provided to the first power transmission link 113-1 by the elastic portion 114 may be increased. In contrast, when the elastic portion 114 is contracted, the tensile force provided to the first power transmission link 113-1 by the elastic portion 114 may be decreased.

Hereinafter, an operation of the upper arm module 110 depending on a relative positional relationship between the upper arm module 110 and the link assembly 120 will be described in detail.

A tensile force applied to the first power transmission link 113-1 by the elastic portion 114 when the upper arm module 110 and the link assembly 120 are in an initial state may be referred to as an initial tensile force. When the upper arm module 110 and the link assembly 120 are in the initial state, the upper arm module 110 and the link assembly 120 may be oriented parallel to each other.

The upper arm module 110 and the link assembly 120 may deviate from the initial state when the user 2 raises the arm. When the upper arm module 110 and the link assembly 120 deviate from the initial state, the upper arm module 110 may be turned relative to the link assembly 120 about the second rotation axis A2 in a first rotation direction thereof. For example, when the upper arm module 110 is turned relative to the link assembly 120 about the second rotation axis A2 in the first rotation direction, the rotary drive portion 112 may move the second power transmission link 113-2 downward.

When the second power transmission link 113-2 is moved downward, the first power transmission link 113-1 may be moved downward. When the first power transmission link 113-1 is moved downward, the elastic portion 114 may be contracted. When the elastic portion 114 is contracted, the tensile force applied to the first power transmission link 113-1 in the downward direction may be decreased. The tensile force applied to the first power transmission link 113-1 in the downward direction by the elastic portion 114 may be decreased with an increase in the rotation angle by which the upper arm module 110 is turned relative to the link assembly 120 in the first rotation direction. As the tensile force applied to the first power transmission link 113-1 by the elastic portion 114 is decreased, the force applied to the upper arm of the user 2 by the muscular force assisting portion 100 may be decreased.

In other words, the assisting force provided to the upper arm of the user 2 while the user 2 raises the arm in the first posture may be gradually decreased. Furthermore, the assisting force provided to the upper arm of the user 2 may be increased while the user 2 lowers the arm in the state in which the arm is raised.

The link assembly 120 may be connected to the one side of the upper arm module 110 to be rotatable about the second rotation axis A2. The link assembly 120 may include a first link 121, a second link 122, a link housing 123, and an angle adjustment portion 124. The first link 121 may form one side of the link assembly 120. Furthermore, the second link 122 may form the opposite side of the link assembly 120. The first link 121 may be connected to the one side of the upper arm module 110 to be rotatable. The first link 121 may include a shaft shape.

The second link 122 may be disposed adjacent to a portion of the user's body to be supported on the user 2. For example, the portion of the user's body may be a portion of the user's body which is located below the shoulder 2a of the user 2. In more detail, the portion of the user's body may be the back or waist of the user 2.

Based on when the muscular strength assisting apparatus 10 is viewed in the direction of the first rotation axis A1, the second link 122 may be located within a reference circle which is a virtual circle whose center passes through the first rotation axis A1 and whose radius is the radius of rotation of the one side of the upper arm module 110. For example, the intersection region 122-2 that will be described below may be located within the reference circle, based on when the muscular strength assisting apparatus 10 is viewed in the direction of the first rotation axis A1.

The second link 122 may include a link body 122-1 and the intersection region 122-2.

The link body 122-1 may include a shaft shape extending between the first link 121 and the intersection region 122-2. For example, one end portion of the first link 121 may be connected to the one side of the upper arm module 110 to be rotatable, and an opposite end portion of the first link 121 may be connected to one end portion of the link body 122-1. Furthermore, an opposite end portion of the link body 122-1 may be connected to the intersection region 122-2. For example, the link body 122-1 may be integrally formed with the intersection region 122-2.

The intersection region 122-2 may cross three rotation axes whose centers cross one another. The three rotation axes may be referred to as the third rotation axis A3, the fourth rotation axis A4, and the fifth rotation axis A5. The intersection region 122-2 may have, for example, a ball shape. For example, the intersection region 122-2 may be fastened with the adapter 30, which will be described below, in a universal ball joint manner. The position of the center of the intersection region 122-2 relative to the adapter 30 may be fixed. In other words, the intersection region 122-2 may be freely turned relative to the adapter 30 in the state in which the center of the intersection region 122-2 is fixed.

The link assembly 120 may further include a length adjustment portion 125 configured for adjusting the lengths of the first link 121 and the second link 122. The length adjustment portion may decrease or increase the separation distance between the intersection region 122-2 and one side of the first link 121. In other words, the overall length of the first link 121 and the second link 122 may be adjusted through the length adjustment portion.

The link housing 123 may connect the first link 121 and the frame 111 to each other. For example, the one side of the first link 121 may be fixed to the link housing 123. Furthermore, the one side of the frame 111 may be connected to the link housing 123 to be rotatable. For example, the link housing 123 and the frame 111 may be connected to be rotatable relative to each other about the second rotation axis A2.

An angle adjustment slit 123a may be formed in the link housing 123. The angle adjustment portion 124 may be inserted into the angle adjustment slit 123a. The angle adjustment slit 123a may extend in a link direction which is the extension direction of the first link 121.

Referring again to FIG. 5, the angle adjustment portion 124 may adjust a muscular strength assisting rotation angle which is a rotation angle formed by the upper arm module 110 and the first and second links 121 and 122. In other words, the rotation angle formed by the upper arm module 110 and the first and second links 121 and 122 may be less than or equal to the muscular strength assisting rotation angle. For example, the muscular strength assisting rotation angle may be decreased when the angle adjustment portion 124 is moved from an end portion of the angle adjustment slit 123a that faces toward the first link toward an end portion of the angle adjustment slit 123a that faces toward the second link. A first link direction may be defined as a direction in which the second link 122 faces toward the first link 121. Furthermore, a second link direction may be defined as a direction opposite to the first link direction thereof.

The muscular strength assisting rotation angle may be, for example, 180° when the angle adjustment portion 124 is located at the end portion of the angle adjustment slit 123a that faces toward the first link. Furthermore, the muscular strength assisting rotation angle may be, for example, 160° when the angle adjustment portion 124 is located at the end portion of the angle adjustment slit 123a that faces toward the second link. In other words, the muscular strength assisting rotation angle may be adjusted to an angle within the range of 160° to 180° through the angle adjustment portion 124.

The angle adjustment portion 124 may be connected to a partial region of the rotary drive portion 112 to be rotatable. For example, the partial region of the rotary drive portion 112 may be spaced from the center of the rotary drive portion 112. Furthermore, the second power transmission link 113-2 may be moved downwards when the angle adjustment portion 124 is moved in the first link direction and may be moved upward when the angle adjustment portion 124 is moved in the second link direction thereof.

Furthermore, the angle adjustment portion 124 may be connected to the first link 121 to slide in the link direction thereof. In other words, the first link 121 may guide movement of the angle adjustment portion 124 in the link direction thereof.

The cuff portion 130 may include a seating cuff 131 and a cuff fastening portion 132. The seating cuff 131 may provide a seating space in which the upper arm of the user 2 is accommodated. The seating cuff 131 may be connected to the opposite side of the upper arm module 110 to slide. For example, the seating cuff 131 may be moved relative to the upper arm module 110 in the direction in which the one side and the opposite side of the upper arm module 110 face toward each other.

The cuff fastening portion 132 may be selectively fastened to a vest fastening portion 22 that will be described below. One side of the cuff fastening portion 132 may be connected to one side of the seating cuff 131, and the cuff fastening portion 132 may include, on an opposite side thereof, a fastening ring which is fastened with the vest fastening portion 22.

The stopper 140 may prevent the upper arm module 110 from being turned relative to the link assembly 120 in a second rotation direction when the upper arm module 110 and the link assembly 120 are in the initial state. The second rotation direction may be defined as a direction opposite to the first rotation direction thereof. The stopper 140 may be disposed on the opposite side of the upper arm module 110.

The first connecting link 200 may connect the muscular strength assisting portion 100 and a shoulder portion 21a of the harness 20 to each other. For example, one side of the first connecting link 200 may be connected to one side of the muscular strength assisting portion 100 (e.g., the upper arm module 110). The position of the one side of the first connecting link 200 relative to the second rotation axis A2 may be fixed. For example, the one side of the first connecting link 200 may be configured to be fastened to a region of the link housing 123 that forms the second rotation axis A2.

Furthermore, the opposite side of the first connecting link 200 may be turned relative to the shoulder 2a of the user 2 about the first rotation axis A1. For example, the opposite side of the first connecting link 200 may be connected to the shoulder portion 21a to be rotatable about the first rotation axis A1.

The extension length of the first connecting link 200 may be greater than or equal to the radius of rotation of the one side of the upper arm module 110. For example, when the opposite side of the first connecting link 200 is spaced from the upper arm module 110 in the direction of the first rotation axis A1, the extension length of the first connecting link 200 may be greater than the radius of rotation of the one side of the upper arm module 110. Furthermore, when the first connecting link 200 is oriented perpendicular to the direction of the first rotation axis A1, the extension length of the first connecting link 200 may correspond to the radius of rotation of the one side of the upper arm module 110.

The first connecting link 200 and the opposite side (e.g., the intersection region 122-2) of the link assembly 120 may be spaced from each other in the direction of the first rotation axis A1. The first connecting link 200 may be formed of, for example, a fabric material. Meanwhile, the spirit and scope of the present disclosure is not limited thereto, and the first connecting link 200 may be formed of an elastic material. In other words, the first connecting link 200 may be formed of a flexible material.

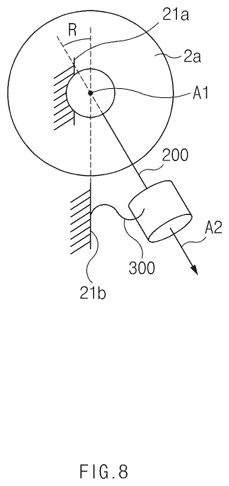

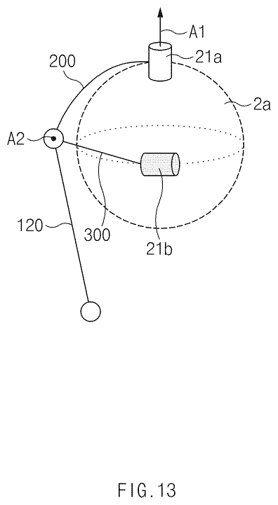

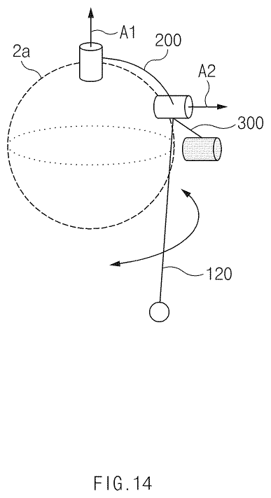

Referring to FIGS. 8 to 14, the second connecting link 300 may allow the one side of the upper arm module 110 to turn around the first rotation center CX1 within a first rotation angle. In other words, the angle by which the one side of the upper arm module 110 turns around the first rotation center CX1 may be less than or equal to the first rotation angle. In more detail, an upper arm rotation angle R which is a rotation angle formed by the upper arm module 110 may be less than or equal to the first rotation angle.

The upper arm rotation angle R may refer to a rotation angle formed by the one side of the upper arm module 110. The upper arm rotation angle R may be defined as an angle formed by a first straight line and a second straight line. The first straight line may be defined as a virtual straight line extending in the direction in which the first rotation axis A1 faces toward the one side of the upper arm module 110. Furthermore, the first straight line may cross the first rotation axis A1 and the one side of the upper arm module 110 when the muscular strength assisting system 1 is viewed in the direction of the first rotation axis A1.

The second straight line may be defined as a virtual straight line extending in the direction in which the first rotation axis A1 faces toward one side of the second connecting link 300. The one side of the second connecting link 300 may refer to a portion of the second connecting link 300 connected to the harness 20. Furthermore, an opposite side of the second connecting link 300 may be connected to the one side of the muscular strength assisting portion 100. For example, the opposite side of the second connecting link 300 may be connected to the first link 121. In another example, the opposite side of the second connecting link 300 may be connected to the one side of the upper arm module 110. In more detail, the opposite side of the second connecting link 300 may be connected to the one side of the frame 111. Furthermore, the second straight line may cross the first rotation axis A1 and the one side of the second connecting link 300 when the muscular strength assisting system 1 is viewed in the direction of the first rotation axis A1.

The position of the second connecting link 300 relative to the second rotation axis A2 may be fixed. For example, the second connecting link 300 may be configured to be fastened to a region of the link housing 123 that provides the second rotation axis A2. The second connecting link 300 and the first connecting link 200 may be connected to each other.

The second connecting link 300 may have, for example, an elastic material. In other words, the second connecting link 300 may include a flexible material which may be elongated. For example, when a first separation distance between an opposite end portion of the first connecting link 200 and one end portion of the second connecting link 300 is less than or equal to a link length, the second connecting link 300 may be placed in a first state in which the length thereof is not increased.

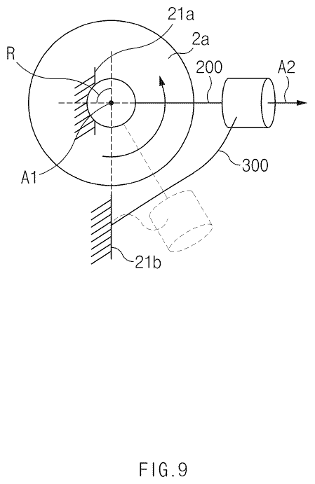

Referring again to FIG. 8 and FIG. 9, the second connecting link 300 may be placed in a state 1-1 when the first separation distance is less than the link length. Furthermore, the second connecting link 300 may be placed in a state 1-2 when the first separation distance and the link length are equal to each other. The state 1-1 and the state 1-2 may be included in the first state. The link length may be defined as the distance between the one end portion and the opposite end portion of the second connecting link 300, based on when the second connecting link 300 in the state 1-2 is oriented in one direction thereof.

When the first separation distance is greater than the link length, the second connecting link 300 may be placed in a second state in which the length thereof is increased. Furthermore, the second connecting link 300 in the state 1-2 may be switched to the second state when the shoulder portion 21a moves a predetermined distance away from a body portion 21b that will be described below.

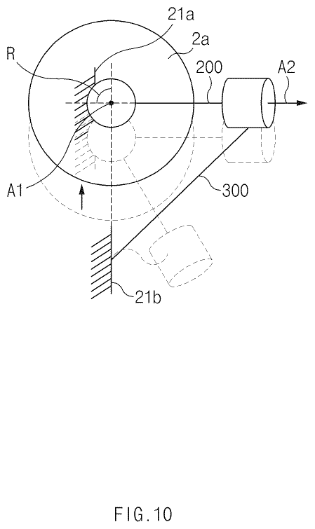

Referring again to FIG. 10, the second connecting link 300 in the state 1-2 may be switched to the second state when the user 2 performs a first operation of protracting the shoulder 2a forward thereof.

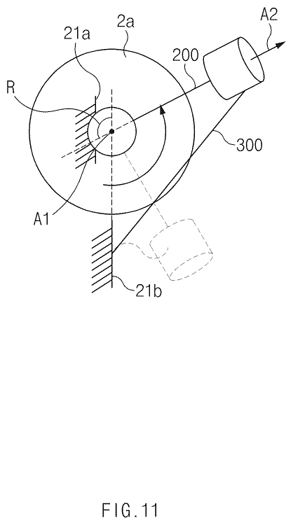

Referring again to FIG. 11, the second connecting link 300 in the state 1-2 may be switched to the second state when the user 2 performs a second operation of turning the upper arm forward around the first rotation center CX1.

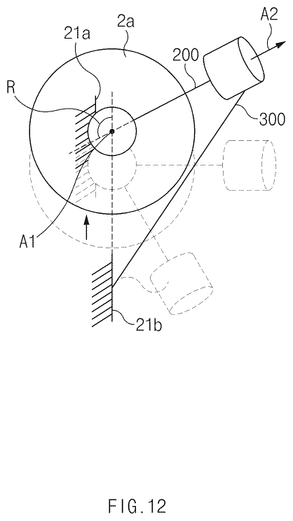

Referring again to FIG. 11 and FIG. 12, the length by which the second connecting link 300 in the state 1-2 is elongated when the user 2 performs the first operation and the second operation may be greater than the length by which the second connecting link 300 in the state 1-2 is elongated when the user 2 performs only one of the first operation and the second operation.

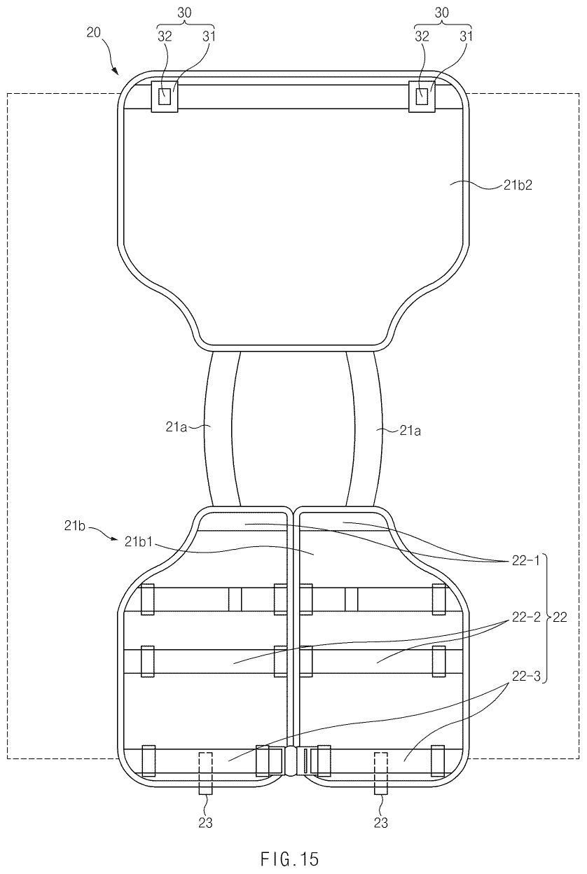

Referring to FIG. 15, the harness 20 may include a wearable vest 21, the vest fastening portion 22, and a reaction force applying portion 23. The wearable vest 21 may be worn on the user 2. When the user 2 wears the wearable vest 21, the wearable vest 21 may be brought into close contact with the body of the user 2. The wearable vest 21 may include the shoulder portion 21a and the body portion 21b.

The shoulder portion 21a may be brought into close contact with the shoulder 2a of the user 2. The first connecting link 200 may be connected to the shoulder portion 21a to be rotatable. The shoulder portion 21a may connect a front body portion 21b1 and a rear body portion 21b2 that will be described below. For example, opposite end portions of the shoulder portion 21a may be connected to an upper end portion of the front body portion 21b1 and an upper end portion of the rear body portion 21b2, respectively.

The body portion 21b may be brought into close contact with the body of the user 2. The body portion 21b may include the front body portion 21b1 and the rear body portion 21b2. The front body portion 21b1 may be brought into close contact with the front side of the body of the user 2. The front body portion 21b1 may form the front side of the body portion 21b. The rear body portion 21b2 may be brought into close contact with the rear side of the body of the user 2. The rear body portion 21b2 may form the rear side of the body portion 21b.

The vest fastening portion 22 may be selectively fastened with the cuff fastening portion 132. The vest fastening portion 22 may be fixedly disposed on the wearable vest 21. For example, the vest fastening portion 22 may be fixedly disposed on the front body portion 21b1. When the vest fastening portion 22 and the cuff fastening portion 132 are fastened with each other, the wearable vest 21 may support the upper arm module 110.

The vest fastening portion 22 may include a plurality of vest fastening portions. The plurality of vest fastening portions 22 may be spaced from each other in the up and down direction thereof. The plurality of vest fastening portions 22 may include an upper fastening portion 22-1, a central fastening portion 22-2, and a lower fastening portion 22-3.

The upper fastening portion 22-1 may be disposed on an upper portion of the body portion 21b (e.g., the front body portion 21b1). The upper portion of the body portion 21b may refer to a region of the body portion 21b brought into close contact with the pectoralis major muscle of the user 2. A state in which the upper fastening portion 22-1 is fastened with the cuff fastening portion 132 may be referred to as an upper fastening state.

The central fastening portion 22-2 may be disposed on a center portion of the body portion 21b (e.g., the front body portion 21b1). The center portion of the body portion 21b may refer to a region of the body portion 21b disposed between the upper portion of the body portion 21b and a lower portion of the body portion 21b. For example, the center portion of the body portion 21b may be brought into close contact with the upper abdomen of the user 2. A state in which the central fastening portion 22-2 is fastened with the cuff fastening portion 132 may be referred to as a central fastening state.

The lower fastening portion 22-3 may be disposed on the lower portion of the body portion 21b (e.g., the front body portion 21b1). The lower portion of the body portion 21b may refer to a region of the body portion 21b brought into close contact with the waist of the user 2. A state in which the lower fastening portion 22-3 is fastened with the cuff fastening portion 132 may be referred to as a lower fastening state.

The vest fastening portion 22 and the cuff fastening portion 132 may be placed in any one state among the upper fastening state, the central fastening state, and the lower fastening state. For example, when the user 2 first wears the harness 20, the vest fastening portion 22 and the cuff fastening portion 132 may be placed in the upper fastening state.

Furthermore, the vest fastening portion 22 and the cuff fastening portion 132 may be switched from the upper fastening state to the central fastening state when the user 2 separates the cuff fastening portion 132 from the upper fastening portion 22-1 and then fastens the separated cuff fastening portion 132 to the central fastening portion 22-2. For example, when the vest fastening portion 22 and the cuff fastening portion 132 are in the upper fastening state, the user 2 may seat the upper arm on the seating cuff 131, may move the upper arm module 110 downward, and may fasten the cuff fastening portion 132 to the central fastening portion 22-2.

Furthermore, the vest fastening portion 22 and the cuff fastening portion 132 may be switched from the central fastening state to the lower fastening state when the user 2 separates the cuff fastening portion 132 from the central fastening portion 22-2 and then fastens the separated cuff fastening portion 132 to the lower fastening portion 22-3.

When a first reaction force is applied to the opposite side (e.g., the intersection region 122-2) of the link assembly 120 by a force (e.g., an external force) applied to the upper arm module 110, the reaction force applying portion 23 may apply a second reaction force to the link assembly 120 to suppress movement of the opposite side of the link assembly 120 relative to the user 2 due to the first reaction force.

For example, when an external force is applied to the upper arm module 110 in the downward direction, the first reaction force may be applied to the intersection region 122-2 in the upward direction by the external force. The reaction force applying portion 23 may suppress movement of the intersection region 122-2 in the upward direction due to the first reaction force. In other words, the reaction force applying portion 23 may suppress movement of the intersection region 122-2 relative to the user 2 in the upward direction due to the first reaction force applied to the intersection region 122-2. The positional balance of the muscular strength assisting portion 100 relative to the harness 20 may be maintained through the reaction force applying portion 23 even though the muscular strength assisting portion 100 is provided on only one of the left and right sides of the harness 20. The reaction force applying portion 23 may be referred to as the “the balancing part” or the “the counterbalancing part”.

The reaction force applying portion 23 may be disposed on a lower portion of the harness 20. For example, the reaction force applying portion 23 may include a plurality of reaction force applying portions, and the plurality of reaction force applying portions may be disposed on the left side and the right side of the lower portion of the body portion 21b, respectively. The reaction force applying portion 23 may have, for example, an annular shape configured for being fastened to pants worn by the user 2.

The reaction force applying portion 23 may be supported on the lower body of the user 2. For example, when the reaction force applying portion 23 is fastened to the pants worn by the user 2, the first reaction force may be applied to the reaction force applying portion 23 in the upward direction by the muscular strength assisting portion 100, and the second reaction force may be applied to the reaction force applying portion 23 in the downward direction by the pants of the user. Through the reaction force applying portion 23, the first reaction force may be canceled by the second reaction force.

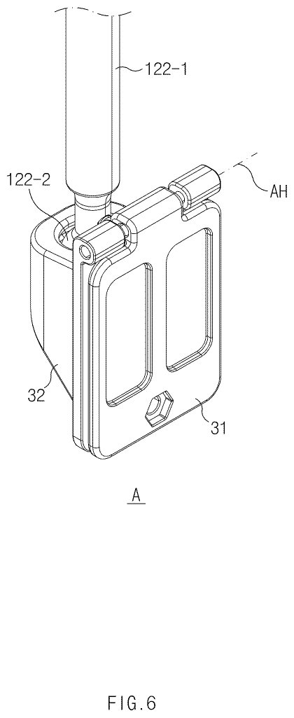

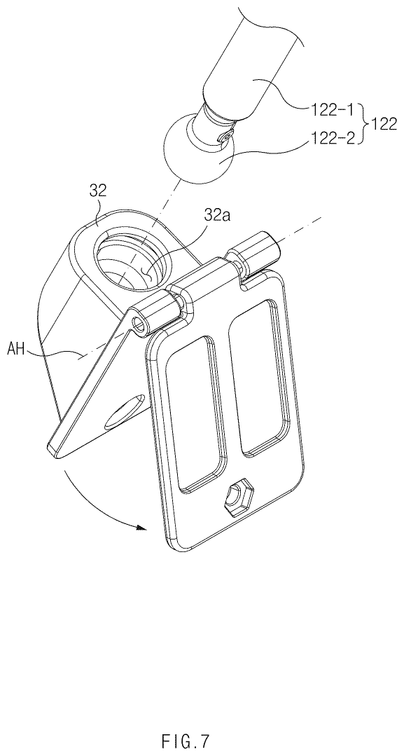

Referring again to FIG. 6 and FIG. 7, the adapter 30 may connect the muscular strength assisting apparatus 10 and the harness 20 to each other. The adapter 30 may be disposed on a lower portion of the rear body portion 21b2. Furthermore, the adapter 30 may include a plurality of adapters, and the plurality of adapters may be disposed on the left side and the right side of the lower portion of the rear body portion 21b2, respectively. The adapter 30 may include a fixed portion 31 and a rotation portion 32.

The fixed portion 31 may be fixed to a portion of the body portion 21b. For example, the fixed portion 31 may be fixed to the lower portion of the rear body portion 21b2. The rotation portion 32 may be connected to the fixed portion 31 to be rotatable. For example, one end portion of the rotation portion 32 may be connected to one end portion of the fixed portion 31 to be rotatable about an adapter rotation axis AH. The adapter rotation axis AH may be defined as a virtual straight line extending in a direction non-parallel to the first rotation axis A1 and passing through the one end portion of the rotation portion 32 and the one end portion of the fixed portion 31.

When the rotation portion 32 is turned relative to the fixed portion 31, an opposite end portion of the rotation portion 32 may be moved toward or away from an opposite end portion of the fixed portion 31. The one end portion and the opposite end portion of the rotation portion 32 may refer to the upper end portion and the lower end portion of the rotation portion 32, respectively. Furthermore, the one end portion and the opposite end portion of the fixed portion 31 may refer to the upper end portion and the lower end portion of the fixed portion 31, respectively.

When the rotation portion 32 is turned relative to the fixed portion 31 in a first adapter rotation direction, the opposite end portion of the rotation portion 32 may be moved away from the opposite end portion of the fixed portion 31. Furthermore, when the rotation portion 32 is turned relative to the fixed portion 31 in a second adapter rotation direction, the opposite end portion of the rotation portion 32 may be moved toward the opposite end portion of the fixed portion 31. The first adapter rotation direction may be opposite to the second adapter rotation direction thereof. For example, when the adapter 30 is viewed in the direction of the adapter rotation axis AH, one of the first adapter rotation direction and the second adapter rotation direction may be the clockwise direction, and the other may be the counterclockwise direction thereof. Furthermore, when the rotation portion 32 is in close contact with the fixed portion 31, the rotation portion 32 may not be turned in the second adapter rotation direction thereof.

The intersection region 122-2 may be connected to the rotation portion 32 to be rotatable about the three rotation axes A3, A4, and A5. The intersection region 122-2 may be disposed between the one end portion and the opposite end portion of the rotation portion 32.

When the rotation portion 32 is turned relative to the fixed portion 31, the intersection region 122-2 may be moved toward or away from the fixed portion 31. For example, when a force is applied to the intersection region 122-2 in the upward direction, the rotation portion 32 in the close-contact state may be turned about the adapter rotation axis AH in the first adapter rotation direction to be moved away from the fixed portion 31. The angle by which the rotation portion 32 in the close-contact state is turned in the first adapter rotation direction may be, for example, 20° or less.

The rotation portion 32 may include a receiving recess 32a formed therein in which the intersection region 122-2 is accommodated. The position of the center of the intersection region 122-2 accommodated in the receiving recess 32a may be fixed relative to the receiving recess 32a. In the state of being accommodated in the receiving recess 32a, the intersection region 122-2 may be turned relative to the receiving recess 32a about the three rotation axes A3, A4, and A5. The rotation portion 32 may include a ring spring that prevents the intersection region 122-2 accommodated in the receiving recess 32a from being separated from the rotation portion 32.

The ring spring may fix the center of the intersection region 122-2 accommodated in the receiving recess 32a with respect to the receiving recess 32a. Furthermore, the ring spring may be brought into close contact with the intersection region 122-2 accommodated in the receiving recess 32a.

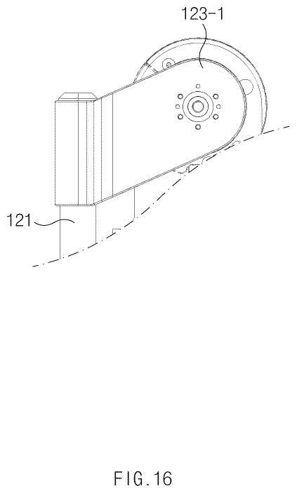

Hereinafter, a link assembly 120 according to another exemplary embodiment of the present disclosure will be described with reference to FIG. 16. The link assembly 120 according to the other embodiment of the present disclosure may not include the angle adjustment portion 124. Furthermore, an angle adjustment slit may not be formed in a link housing 123-1.

The muscular strength assisting apparatus according to an exemplary embodiment of the present disclosure may be independently supported on the user without any other muscular strength assisting apparatus. Accordingly, the muscular strength assisting apparatus may be prevented from deviating from the state in which the position relative to the user's shoulder is aligned.

Furthermore, the muscular strength assisting apparatus may be selectively used for only one of the left upper arm and the right upper arm of the user that requires muscular strength assistance. Accordingly, unnecessary muscular strength assistance may be prevented from being applied to the other one of the left upper arm and the right upper arm that does not require muscular strength assistance.

Hereinabove, even though all of the components are coupled into one body or operate in a combined state in the description of the above-mentioned embodiments of the present disclosure, the present disclosure is not limited to these embodiments. That is, all of the components may operate in one or more selective combination within the range of the purpose of the present disclosure. It should be also understood that the terms of “include”, “comprise” or “have” in the specification are “open type” expressions just to say that the corresponding components exist, and unless described to the contrary, do not exclude but may include additional components. Unless otherwise defined, all terms used herein, including technical and scientific terms, include the same meaning as those generally understood by those skilled in the art to which the present disclosure pertains. Such terms as those defined in a generally used dictionary are to be interpreted as including meanings equal to the contextual meanings in the relevant field of art, and are not to be interpreted as including ideal or excessively formal meanings unless clearly defined as including such in the present application.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A muscular strength assisting apparatus comprising:
a muscular strength assisting portion configured to assist a user's muscular strength; and
a first connecting link including one side connected to one side of the muscular strength assisting portion and an opposite side rotatable relative to a shoulder of the user about a first rotation axis,
wherein the muscular strength assisting portion includes:
an upper arm module configured to assist muscular strength of an upper arm of the user; and
a link assembly including one side connected to one side of the upper arm module to be rotatable about a second rotation axis non-parallel to the first rotation axis and an opposite side disposed adjacent to a portion of a body of the user to be supported on the user.

2. The muscular strength assisting apparatus of claim 1, wherein the one side of the upper arm module is turned around a virtual first rotation center extending along the first rotation axis.

3. The muscular strength assisting apparatus of claim 1, wherein the first connecting link and the opposite side of the link assembly are spaced from each other in a direction of the first rotation axis.

4. The muscular strength assisting apparatus of claim 1, wherein the upper arm module is spaced from a virtual straight line passing through the opposite side of the first connecting link and the opposite side of the link assembly.

5. The muscular strength assisting apparatus of claim 2, wherein a direction perpendicular to an extension direction of the first rotation axis is referred to as a radial direction, and a radius of rotation of the one side of the upper arm module is a separation distance between the first rotation axis and the one side of the upper arm module in the radial direction.

6. The muscular strength assisting apparatus of claim 5, wherein in a state that the muscular strength assisting apparatus is viewed in a direction of the first rotation axis, the opposite side of the link assembly is located within a virtual circle whose center passes through the first rotation axis and whose radius is the radius of rotation of the one side of the upper arm module.

7. The muscular strength assisting apparatus of claim 2, further including:
a second connecting link configured to allow the one side of the upper arm module to turn around the first rotation center within a range of a first rotation angle.

8. The muscular strength assisting apparatus of claim 7, wherein the second connecting link has one side fixed in position relative to the body of the user and an opposite side connected to the one side of the muscular strength assisting portion.

9. The muscular strength assisting apparatus of claim 8,
wherein in a state that the muscular strength assisting apparatus is viewed along the first rotation axis, a virtual straight line extending in a direction in which the first rotation axis faces toward the one side of the upper arm module is referred to as a first straight line, and a virtual straight line extending in a direction in which the first rotation axis faces toward the one side of the second connecting link is referred to as a second straight line,
wherein an upper arm rotation angle formed by the one side of the upper arm module is defined as an angle formed by the first straight line and the second straight line, and
wherein the upper arm rotation angle is less than or equal to the first rotation angle.

10. The muscular strength assisting apparatus of claim 7, wherein the second connecting link includes an elastic material.

11. A muscular strength assisting system comprising:
a muscular strength assisting apparatus configured to assist a user's muscular strength;
a harness including a shoulder portion configured to be brought into contact with a shoulder of the user and a body portion configured to be brought into contact with a body of the user; and
an adapter configured to connect the harness and the muscular strength assisting apparatus to each other,
wherein the muscular strength assisting apparatus includes:
a muscular strength assisting portion configured to assist the user's muscular strength; and
a first connecting link including one side connected to one side of the muscular strength assisting portion and an opposite side connected to the shoulder portion to be rotatable about a first rotation axis, and
wherein the muscular strength assisting portion includes:
an upper arm module configured to assist muscular strength of an upper arm of the user; and
a link assembly including one side connected to one side of the upper arm module to be rotatable about a second rotation axis non-parallel to the first rotation axis and an opposite side connected to a portion of the body portion by the adapter.

12. The muscular strength assisting system of claim 11, wherein the adapter includes:
a fixed portion fixed to a portion of the body portion; and
a rotation portion connected to the fixed portion to be rotatable.

13. The muscular strength assisting system of claim 12,
wherein the opposite side of the link assembly includes an intersection region configured to cross three rotation axes whose centers cross one another and configured to turn about the three rotation axes, and
wherein the intersection region is rotatably connected to the rotation portion so that a center of the intersection region is fixed relative to the rotation portion in a situation that the intersection region is turned about the three rotation axes.

14. The muscular strength assisting system of claim 13, wherein the intersection region is moved toward or away from the fixed portion in a situation that the rotation portion is turned relative to the fixed portion.

15. The muscular strength assisting system of claim 14,
wherein one end portion of the rotation portion is connected to one end portion of the fixed portion to be rotatable,
wherein an opposite end portion of the rotation portion is moved toward or away from an opposite end portion of the fixed portion in a situation that the rotation portion is turned relative to the fixed portion, and
wherein the intersection region is disposed between the one end portion of the rotation portion and the opposite end portion of the rotation portion.

16. The muscular strength assisting system of claim 11, wherein the muscular strength assisting portion further includes:
a seating cuff on which the upper arm of the user is accommodated, the seating cuff being connected to the upper arm module; and
a cuff fastening portion connected to the seating cuff and fastened to the harness, and
wherein the harness includes:
a wearable vest configured to form the shoulder portion and the body portion; and
a vest fastening portion fixedly disposed on the wearable vest and selectively fastened with the cuff fastening portion.

17. The muscular strength assisting system of claim 16,
wherein the vest fastening portion includes a plurality of vest fastening portions disposed on an upper portion, a center portion, and a lower portion of the body portion, respectively, and
wherein the upper portion of the body portion is configured to be brought into contact with a pectoralis major muscle of the user, the lower portion of the body portion is configured to be brought into contact with a waist of the user, and the center portion of the body portion is disposed between the upper portion of the body portion and the lower portion of the body portion.

18. The muscular strength assisting system of claim 11, wherein the harness further includes a reaction force applying portion configured to apply a second reaction force to the link assembly to suppress movement of the opposite side of the link assembly relative to the user due to a first reaction force in response that the first reaction force is applied to the opposite side of the link assembly by a force applied to the upper arm module.

19. The muscular strength assisting system of claim 18, wherein the reaction force applying portion is disposed on a lower portion of the harness and supported on a lower body of the user.
